(19) United States
(12) Patent Application Publication
(10) Pub. No.: US 2025/0226762 A1
(43) Pub. Date: Jul. 10, 2025

(54) OUTPUT POTENTIAL SWITCHING CIRCUIT

(71) Applicant: Denso Corporation, Kariya-city (JP)

(72) Inventor: Masahiro KUSUMOTO, Kariya-city (JP)

(73) Assignee: Denso Corporation, Kariya-city (JP)

(21) Appl. No.: 19/089,844

(22) Filed: Mar. 25, 2025

Related U.S. Application Data
(63) Continuation of application No. PCT/JP2023/031831, filed on Aug. 31, 2023.

(30) Foreign Application Priority Data
Sep. 28, 2022 (JP) 2022-155005

(51) Int. Cl. H02M 7/483; H02M 7/537

(52) U.S. Cl. CPC H02M 7/483; H02M 7/537

(57) ABSTRACT

An output potential switching circuit is applied to a multilevel inverter, and supplies multilevel potentials and switches the output potential to one of the multilevel potentials. The output potential switching circuit including a plurality of semiconductor modules which includes a first switching element with a first diode connected in inverse parallel, a second switching element with a second diode connected in inverse parallel, a P terminal to which a positive terminal of the first switching element is connected, an O terminal to which a negative terminal of the first switching element and a positive terminal of the second switching element are connected, and an N terminal to which a negative terminal of the second switching element is connected, and the P terminal of one of the semiconductor modules is connected to the O terminal of another one of the semiconductor modules.

### CROSS-REFERENCE TO RELATED APPLICATION

This application is the U.S. bypass application of International Application No. PCT/JP2023/031831 filed on Aug. 31, 2023 which designated the U.S. and claims priority to Japanese Patent Application No. 2022-155005 filed on Sep. 28, 2022, the contents of both of which are incorporated herein by reference.

### TECHNICAL FIELD

The present disclosure relates to an output potential switching circuit applicable to a multilevel inverter.

### BACKGROUND

Conventionally, in semiconductor modules applied to 3-level inverters, a series connection circuit of an IGBT connected between PN of a DC power supply and an AC switch element connected between a series connection point of the series connection circuit and the neutral point of the DC power supply are built in a single package (refer to JP 2008-193779A). This configuration is said to enable a reduction in wiring inductance and a reduction in the cost of the device.

### SUMMARY

A first aspect of the present disclosure is:

An output potential switching circuit applicable to a multilevel inverter, and supplies multilevel potentials and switches an output potential to one of the multilevel potentials, the output potential switching circuit including:
a plurality of semiconductor modules including a first switching element with a first diode connected in inverse parallel, a second switching element with a second diode connected in inverse parallel, a P terminal to which a positive terminal of the first switching element is connected, an O terminal to which a negative terminal of the first switching element and a positive terminal of the second switching element are connected, and an N terminal to which a negative terminal of the second switching element is connected,
wherein, the P terminal of one of the semiconductor modules is connected to the O terminal of another one of the semiconductor modules.

### BRIEF DESCRIPTION OF THE DRAWINGS

The above features of the present disclosure will be made clearer by the following detailed description, given referring to the appended drawings. In the accompanying drawings:

FIG. 1 shows a schematic diagram of a power card circuit configuration;

FIG. 2 shows a schematic view of the front of a power card;

FIG. 3 shows a schematic view of the top of the power card;

FIG. 4 shows a circuit diagram of an output potential switching circuit applied to a 3-level inverter of a first embodiment;

FIG. 5 shows a plan view of the power card arrangement;

FIG. 6 shows a circuit diagram of the output potential switching circuit and its peripheral components of the first embodiment;

FIG. 7 shows a circuit diagram of current flow when switching elements are switched;

FIG. 8 shows a circuit diagram of the output potential switching circuit applied to a 5-level inverter;

FIG. 9 shows a plan view of a modified power card arrangement;

FIG. 10 shows a front view of another modified power card arrangement;

FIG. 11 shows a schematic view of the front of a modified power card;

FIG. 12 shows a plan view of another modified power card arrangement;

FIG. 13 shows a circuit diagram of an output potential switching circuit applied to a 3-level inverter of a second embodiment;

FIG. 14 shows a schematic view of the front of the power card;

FIG. 15 shows a plan view of the power card arrangement;

FIG. 16 shows a circuit diagram of the output potential switching circuit and its peripheral components of the second embodiment;

FIG. 17 shows a circuit diagram of current flow when switching elements are switched;

FIG. 18 shows a circuit diagram of the output potential switching circuit applied to a 5-level inverter;

FIG. 19 shows a plan view of a modified power card arrangement;

FIG. 20 shows a front view of another modified power card arrangement;

FIG. 21 shows a plan view of another modified power card arrangement;

FIG. 22 shows a schematic diagram of a modified power card circuit configuration; and

FIG. 23 shows a circuit diagram of a conventional 3-level inverter and its peripheral components.

### DETAILED DESCRIPTION OF THE PREFERRED EMBODIMENTS

To produce the semiconductor module (output potential switching circuit) described in JP 2008-193779A, it is necessary to develop a dedicated semiconductor module and set up a new production line. This may increase the total cost of producing semiconductor modules.

The present disclosure has been made to solve the above problem, and the main purpose of which is to configure an output potential switching circuit applicable to a multilevel inverter using a general-purpose semiconductor module.

A first aspect of the present disclosure is:

An output potential switching circuit applicable to a multilevel inverter, and supplies multilevel potentials and switches an output potential to one of the multilevel potentials, the output potential switching circuit including:
a plurality of semiconductor modules including a first switching element with a first diode connected in inverse parallel, a second switching element with a second diode connected in inverse parallel, a P terminal to which a positive terminal of the first switching element is connected, an O terminal to which a negative terminal of the first switching element and a positive terminal of the second switching element are connected, and an N terminal to which a negative terminal of the second switching element is connected, wherein, the P terminal of one of the semiconductor modules is connected to the O terminal of another one of the semiconductor modules.

According to the above configuration, the output potential switching circuit is applied to a multilevel inverter, supplies a multilevel potential, and switches the output potential to one of the multilevel potentials.

Here, the output potential switching circuit includes a plurality of semiconductor modules (hereinafter referred to as general-purpose semiconductor modules), each of which has the first switching element with the first diode connected in inverse parallel, the second switching element with the second diode connected in inverse parallel, the P terminal to which the positive terminal of the first switching element is connected, the O terminal to which the negative terminal of the first switching element and the positive terminal of the second switching element are connected, and the N terminal to which the negative terminal of the second switching element is connected. A general-purpose semiconductor module is a semiconductor module that is used in general-purpose 3-phase 2-level inverters, etc., and constitutes a circuit for one phase.

Then, the P terminal of one of the semiconductor modules (hereinafter referred to as a first semiconductor module) is connected to the O terminal of another one of the semiconductor modules (hereinafter referred to as a second semiconductor module), respectively. Thus, for example, if the output potential switching circuit is composed only of the first semiconductor module and the second semiconductor module, by supplying the positive potential to the P terminal of the second semiconductor module, supplying the neutral point potential to the N terminal of the second semiconductor module, supplying the negative potential to the N terminal of the first semiconductor module, and operating the first and second switching elements of the semiconductor modules, the output potential output from the O terminal of the first semiconductor module can be switched to one of the positive potential, neutral point potential, and negative potential. Therefore, the output potential switching circuit applicable to multilevel inverters can be configured using general-purpose semiconductor modules.

It should be noted that when the P terminal of the second semiconductor module (one of the semiconductor modules) is connected to the O terminal of another one of the semiconductor modules (hereinafter referred to as a third semiconductor module), by supplying the positive potential to the P terminal of the third semiconductor module, supplying the first intermediate potential to the N terminal of the second semiconductor module, supplying the second intermediate potential to the N terminal of the first semiconductor module, and supplying the negative potential to the N terminal of the first semiconductor module, an output potential switching circuit applicable to a 4-level inverter can be configured. In the same way, by adding more general-purpose semiconductor modules, output potential switching circuits applicable to inverters with five or more levels can also be configured.

A second aspect of the present disclosure is:
the semiconductor module is formed in a plate shape, and the P terminal, the N terminal, and the O terminal are arranged side by side in this order at an edge of the semiconductor module in a predetermined direction, and the one of the semiconductor modules and the other one of the semiconductor modules are arranged in a stacked manner with the front and back facing away from each other in the thickness direction so that the P terminal of the one of the semiconductor modules and the O terminal of the other one of the semiconductor modules face each other.

According to the above configuration, since the P terminal of the one of the semiconductor modules and the O terminal of the other one of the semiconductor modules face each other, it becomes easier to connect the P terminal of the one of the semiconductor modules to the O terminal of the other one of the semiconductor modules. Furthermore, since the direction of current flow to the P terminal of the one of the semiconductor modules is opposite to the direction of current flow to the O terminal of the other one of the semiconductor modules, the inductance of these terminals can be reduced to reduce losses. Moreover, since the one of the semiconductor modules and the other one of the semiconductor modules are arranged in an inverted manner and stacked in the thickness direction, the space required for arranging the multiple semiconductor modules can be reduced.

A third aspect of the present disclosure is:
the semiconductor module is formed in a plate shape, and the P terminal, the N terminal, and the O terminal are arranged side by side in this order at an edge of the semiconductor module in a predetermined direction, and the one of the semiconductor modules and the other one of the semiconductor modules are arranged side by side in the thickness direction and facing the same direction on the front and back, so that the P terminal of the one of the semiconductor modules faces the O terminal of the other one of the semiconductor modules.

According to the above configuration, since the P terminal of the one of the semiconductor modules and the O terminal of the other one of the semiconductor modules face each other, it becomes easier to connect the P terminal of the one of the semiconductor modules to the O terminal of the other one of the semiconductor modules. Furthermore, since the direction of current flow to the P terminal of the one of the semiconductor modules is opposite to the direction of current flow to the O terminal of the other one of the semiconductor modules, the inductance of these terminals can be reduced to reduce losses.

A fourth aspect of the present disclosure is:
the semiconductor module is formed in a plate shape, and the P terminal, the N terminal, and the O terminal are arranged side by side in this order at an edge of the semiconductor module in a predetermined direction, and the one of the semiconductor modules and the other one of the semiconductor modules are arranged with the fronts and backs facing the same direction and aligned in the direction in which the P terminals, the N terminals, and the O terminals are arranged, so that the P terminal of the one of the semiconductor modules and the O terminal of the other one of the semiconductor modules are arranged adjacent to each other.

According to the above configuration, since the P terminal of the one of the semiconductor modules and the O terminal of the other one of the semiconductor modules are adjacent to each other, it becomes easier to connect the P terminal of the one of the semiconductor modules to the O terminal of the other one of the semiconductor modules. Furthermore, since the direction of current flow to the P terminal of the one of the semiconductor modules is opposite to the direction of current flow to the O terminal of the other one of the semiconductor modules, the inductance of these terminals can be reduced to reduce losses.

A fifth aspect of the present disclosure is:
the semiconductor module is formed in a plate shape, and the P terminal, the O terminal, and the N terminal are arranged side by side in this order at an edge of the semiconductor module in a predetermined direction, and the one of the semiconductor modules and the other one of the semiconductor modules are arranged side by side in the thickness direction and facing the same direction or the opposite direction on the front and back, so that the P terminal of the one of the semiconductor modules faces the O terminal of the other one of the semiconductor modules.

According to the above configuration, since the P terminal of the one of the semiconductor modules and the O terminal of the other one of the semiconductor modules face each other, it becomes easier to connect the P terminal of the one of the semiconductor modules to the O terminal of the other one of the semiconductor modules. Furthermore, since the direction of current flow to the P terminal of the one of the semiconductor modules is opposite to the direction of current flow to the O terminal of the other one of the semiconductor modules, the inductance of these terminals can be reduced to reduce losses.

Specifically, as in a sixth aspect, a configuration such that the O terminal of the semiconductor module, to which the lowest potential of the multi-level potential is supplied to the N terminal, is connected to one phase coil of the rotating electric machine, and a potential of the multi-level potential higher than the potential supplied to the N terminal of the one of the semiconductor modules is supplied to the N terminal of the other one of the semiconductor modules, can be adopted. According to this configuration, one output potential switching circuit is associated with one phase coil of the rotating electric machine, and the potential output to one phase coil of the rotating electric machine can be switched to a multi-level potential.

A seventh aspect of the present disclosure is:

An output potential switching circuit applicable to a multilevel inverter, and supplies multilevel potentials and switches an output potential to one of the multilevel potentials, the output potential switching circuit including
a plurality of semiconductor modules including a first switching element with a first diode connected in inverse parallel, a second switching element with a second diode connected in inverse parallel, a P terminal to which a positive terminal of the first switching element is connected, an O terminal to which a negative terminal of the first switching element and a positive terminal of the second switching element are connected, and an N terminal to which a negative terminal of the second switching element is connected,
wherein, the N terminal of one of the semiconductor modules is connected to the O terminal of another one of the semiconductor modules.

According to the above configuration, as in the first aspect, the output potential switching circuit includes a plurality of general-purpose semiconductor modules. Then, the N terminal of one of the semiconductor modules (hereinafter referred to as a first semiconductor module) is connected to the O terminal of another one of the semiconductor modules (hereinafter referred to as second semiconductor module), respectively. Thus, for example, if the output potential switching circuit is composed only of the first semiconductor module and the second semiconductor module, by supplying the positive potential to the P terminal of the first semiconductor module, supplying the neutral point potential to the P terminal of the second semiconductor module, supplying the negative potential to the N terminal of the second semiconductor module, and operating the first and second switching elements of the semiconductor modules, the output potential output from the O terminal of the first semiconductor module can be switched to one of the positive potential, neutral point potential, and negative potential. Therefore, the output potential switching circuit applicable to multilevel inverters can be configured using general-purpose semiconductor modules.

It should be noted that when the N terminal of the second semiconductor module (one of the semiconductor modules) is connected to the O terminal of another one of the semiconductor modules (hereinafter referred to as a third semiconductor module), by supplying the positive potential to the P terminal of the first semiconductor module, supplying the first intermediate potential to the P terminal of the second semiconductor module, supplying the second intermediate potential to the P terminal of the third semiconductor module, and supplying the negative potential to the N terminal of the third semiconductor module, an output potential switching circuit applicable to a 4-level inverter can be configured. In the same way, by adding more general-purpose semiconductor modules, output potential switching circuits applicable to inverters with five or more levels can also be configured.

An eighth aspect of the present disclosure is:
the semiconductor module is formed in a plate shape, and the N terminal, the P terminal, and the O terminal are arranged side by side in this order at an edge of the semiconductor module in a predetermined direction, and the one of the semiconductor modules and the other one of the semiconductor modules are arranged in a stacked manner with the front and back facing away from each other in the thickness direction so that the N terminal of the one of the semiconductor modules and the O terminal of the other one of the semiconductor modules face each other.

According to the above configuration, since the N terminal of the one of the semiconductor modules and the O terminal of the other one of the semiconductor modules face each other, it becomes easier to connect the N terminal of the one of the semiconductor modules to the O terminal of the other one of the semiconductor modules. Furthermore, since the direction of current flow to the N terminal of the one of the semiconductor modules is opposite to the direction of current flow to the O terminal of the other one of the semiconductor modules, the inductance of these terminals can be reduced to reduce losses. Moreover, since the one of the semiconductor modules and the other one of the semiconductor modules are arranged in an inverted manner and stacked in the thickness direction, the space required for arranging the multiple semiconductor modules can be reduced.

A ninth aspect of the present disclosure is:
the semiconductor module is formed in a plate shape, and the N terminal, the P terminal, and the O terminal are arranged side by side in this order at an edge of the semiconductor module in a predetermined direction, and the one of the semiconductor modules and the other one of the semiconductor modules are arranged side by side in the thickness direction and facing the same direction on the front and back, so that the N terminal of the one of the semiconductor modules faces the O terminal of the other one of the semiconductor modules.

According to the above configuration, since the N terminal of the one of the semiconductor modules and the O terminal of the other one of the semiconductor modules face each other, it becomes easier to connect the P terminal of the one of the semiconductor modules to the O terminal of the other one of the semiconductor modules. Furthermore, since the direction of current flow to the N terminal of the one of the semiconductor modules is opposite to the direction of current flow to the O terminal of the other one of the semiconductor modules, the inductance of these terminals can be reduced to reduce losses.

A tenth aspect of the present disclosure is:
the semiconductor module is formed in a plate shape, and the N terminal, the P terminal, and the O terminal are arranged side by side in this order at an edge of the semiconductor module in a predetermined direction, and the one of the semiconductor modules and the other one of the semiconductor modules are arranged with the fronts and backs facing the same direction and aligned in the direction in which the N terminals, the P terminals, and the O terminals are arranged, as the N terminal of the one of the semiconductor modules and the O terminal of the other one of the semiconductor modules are arranged adjacent to each other.

According to the above configuration, since the N terminal of the one of the semiconductor modules and the O terminal of the other one of the semiconductor modules are adjacent to each other, it becomes easier to connect the P terminal of the one of the semiconductor modules to the O terminal of the other one of the semiconductor modules. Furthermore, since the direction of current flow to the N terminal of the one of the semiconductor modules is opposite to the direction of current flow to the O terminal of the other one of the semiconductor modules, the inductance of these terminals can be reduced to reduce losses.

An eleventh aspect of the present disclosure is:
the semiconductor module is formed in a plate shape, and the P terminal, the O terminal, and the N terminal are arranged side by side in this order at an edge of the semiconductor module in a predetermined direction, and the one of the semiconductor modules and the other one of the semiconductor modules are arranged side by side in the thickness direction and facing the same direction or the opposite direction on the front and back, so that the N terminal of the one of the semiconductor modules faces the O terminal of the other one of the semiconductor modules.

According to the above configuration, since the N terminal of the one of the semiconductor modules and the O terminal of the other one of the semiconductor modules face each other, it becomes easier to connect the N terminal of the one of the semiconductor modules to the O terminal of the other one of the semiconductor modules. Furthermore, since the direction of current flow to the N terminal of the one of the semiconductor modules is opposite to the direction of current flow to the O terminal of the other one of the semiconductor modules, the inductance of these terminals can be reduced to reduce losses.

Specifically, as in the twelfth aspect, a configuration such that the O terminal of the semiconductor module, to which the highest potential of the multi-level potential is supplied to the P terminal, is connected to one phase coil of the rotating electric machine, and a potential of the multi-level potential lower than the potential supplied to the P terminal of the one of the semiconductor modules is supplied to the P terminal of the other one of the semiconductor modules, can be adopted. According to this configuration, one output potential switching circuit is associated with one phase coil of the rotating electric machine, and the potential output to one phase coil of the rotating electric machine can be switched to a multi-level potential.

A thirteenth aspect of the present disclosure is:
An output potential switching circuit applicable to a multilevel inverter, and supplies multilevel potentials and switches an output potential to one of the multilevel potentials, the output potential switching circuit including a plurality of semiconductor modules including: a first switching element with a first diode connected in inverse parallel, a second switching element with a second diode connected in inverse parallel, a P terminal to which a positive terminal of the first switching element is connected, an O terminal to which a negative terminal of the first switching element and a positive terminal of the second switching element are connected, and an N terminal to which a negative terminal of the second switching element is connected,
wherein, only the first diode, the first switching element, the second diode, and the second switching element are provided as elements, and no other elements are provided.

According to the above configuration, as in the first aspect, the output potential switching circuit includes a plurality of general-purpose semiconductor modules. For example, by connecting the P terminal of one of the semiconductor modules (hereinafter referred to as a first semiconductor module) to the O terminal of another one of the semiconductor modules (hereinafter referred to as a second semiconductor module) respectively, the same effect of the first aspect can be achieved. In addition, by connecting the N terminal of the first semiconductor module to the O terminal of the second semiconductor module, respectively, the same effect as the seventh aspect can be achieved. Furthermore, the output potential switching circuit has only the first diode, the first switching element, the second diode, and the second switching element as elements and no other elements. Therefore, the output potential switching circuit can be configured without requiring elements other than those included in general-purpose semiconductor modules.

### First Embodiment

The first embodiment embodied in an output potential switching circuit applied to a 3-level inverter (multi-level inverter) that converts power between a DC power source and a rotating electric machine installed in a vehicle will be described below, with reference to the drawings. Vehicles can be electric or hybrid vehicles. A rotating electric machine includes motors, generators, MGs (Motor Generators), etc.

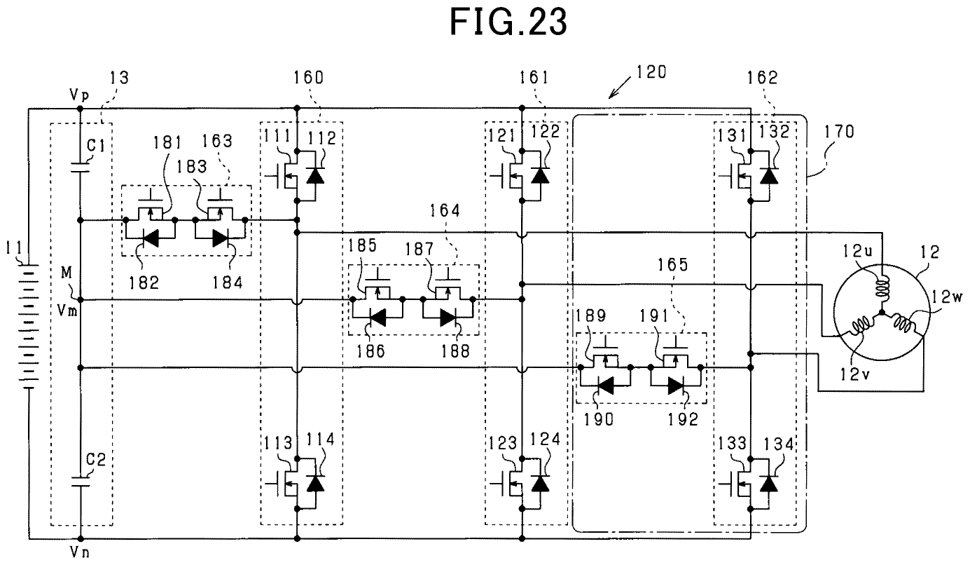

FIG. 23 shows a circuit diagram of a conventional 3-level inverter and its peripheral components. The voltage Vh of a battery 11 is divided by capacitors C1 and C2 into voltages Vh/2 each and supplied to an inverter 120. As a result, the capacitors C1 and C2 function as a DC power supply 13 that outputs three levels of potential. Here, a positive potential Vp is a potential of a positive pole side of the capacitor C1, a negative potential Vn is a potential of a negative pole side of the capacitor C2, and a neutral point potential Vm is a potential of a connection point (a neutral point M) between the negative pole side of the capacitor C1 and the positive pole side of the capacitor C2.

A series-connected circuit of MOSFETs with diodes connected in inverse parallel is connected between the positive potential Vp and the negative potential Vn for three phases. In other words, a series connection circuit 160 for a U phase is composed of a series connection circuit with an upper arm consisting of a MOSFET 111 with a diode 112 connected in inverse parallel and a lower arm consisting of a MOSFET 113 with a diode 114 connected in inverse parallel. A series connection circuit 161 for a V phase is composed of a series connection circuit with an upper arm consisting of a MOSFET 121 with a diode 122 connected in inverse parallel and a lower arm consisting of a MOSFET 123 with a diode 124 connected in inverse parallel. A series connection circuit 162 for a W phase is composed of a series connection circuit with an upper arm consisting of a MOSFET 131 with a diode 132 connected in inverse parallel and the lower arm consisting of a MOSFET 133 with a diode 134 connected in inverse parallel.

An AC switch composed of a MOSFET with diodes connected in inverse series is connected between the series connection points of the upper and lower arms of the series-connected circuit of each phase and the neutral point potential Vm. In other words, an AC switch circuit 163 has a configuration in which a source of a MOSFET 181 with a diode 182 connected in inverse parallel and a source of a MOSFET 183 with a diode 184 in inverse parallel are connected between a series connection point of the series connection circuit 160 for the U phase and the neutral point M of the DC power supply 13. An AC switch circuit 164 has a configuration in which a source of a MOSFET 185 with a diode 186 connected in inverse parallel and a source of a MOSFET 187 with a diode 188 in inverse parallel are connected between a series connection point of the series connection circuit 161 for the V phase and the neutral point M of the DC power supply 13. An AC switch circuit 165 has a configuration in which a source of a MOSFET 189 with a diode 190 connected in reverse parallel and a source of a MOSFET 191 with a diode 192 in reverse parallel are connected between a series connection point of the series connection circuit 162 for the W phase and the neutral point M of the DC power supply 13. In addition, the series connection point of each series connection circuit 160, 161, 162 is an AC output and is connected to each phase coil 12u, 12v, 12w of a rotating electric machine 12.

According to the above configuration, the series connection points of each series connection circuit 160, 161, and 162 can output positive potential Vp, negative potential Vn, and neutral point potential Vm, resulting in a 3-level inverter output.

In the present embodiment, for example, a circuit 170 for one phase, which is composed of the series connection circuit 162 and the AC switch circuit 165 for the W phase, is composed of two power cards. A power card (general-purpose semiconductor module, semiconductor module) is a semiconductor module that is used in general-purpose 3-phase, 2-level inverters, etc., and constitute a circuit for one phase.

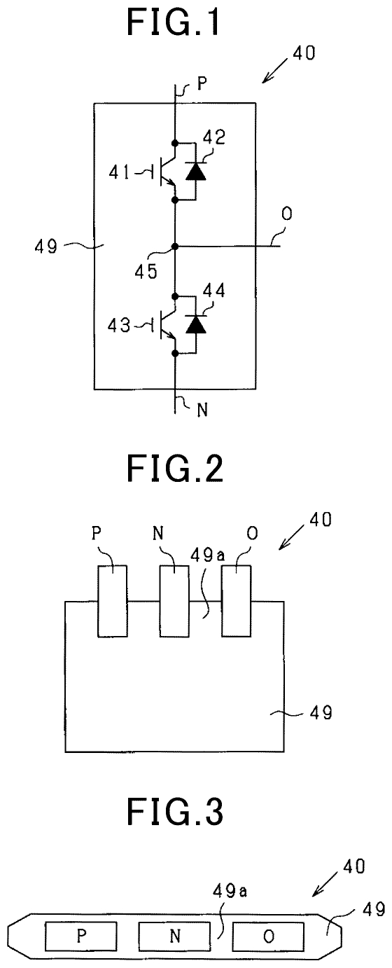

FIG. 1 shows a schematic diagram of a circuit configuration of a power card 40. The power card 40 (2-in-1 module) has a first switching element 41, a first diode 42, a second switching element 43, a second diode 44, a P terminal, an O terminal, an N terminal, and a mold resin 49. The first switching element 41 is a semiconductor element such as an IGBT (Insulated Gate Bipolar Transistor) or a MOSFET (Metal-Oxide-Semiconductor Field-Effect Transistor). An IGBT is used here as an example. The first diode 42 is connected in reverse parallel to the first switching element 41. The second diode 44 is connected in reverse parallel to the second switching element 43. The P terminal is connected to a collector (a positive terminal) of the first switching element 41. An emitter (a negative terminal) of the first switching element 41 is connected to a collector (a positive terminal) of the second switching element 43. The emitter of the first switching element 41 and the collector of the second switching element 43 are connected to the O terminal. That is, a series connection point 45 between the first switching element 41 and the second switching element 43 is connected to the O terminal. The N terminal is connected to an emitter (a negative terminal) of the second switching element 43. Then, the first switching element 41, the first diode 42, the second switching element 43, and the second diode 44 are encapsulated by the mold resin 49 (a sealing resin).

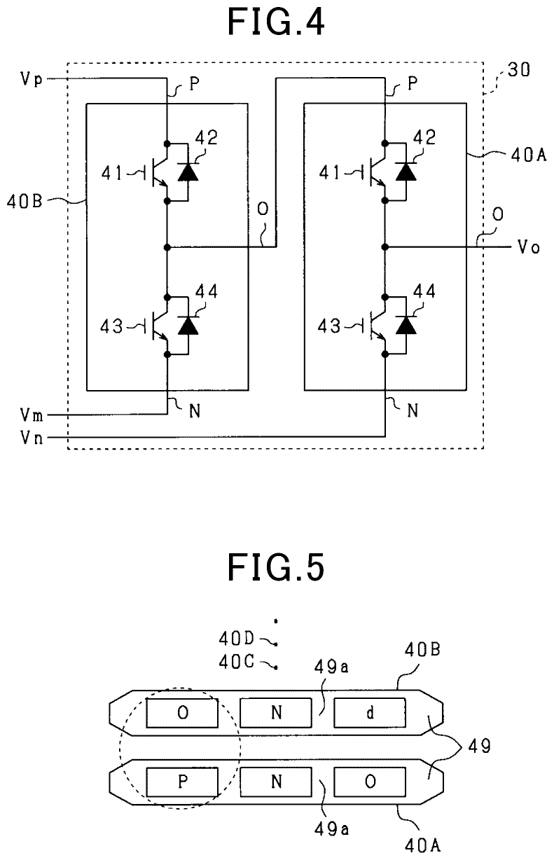

FIG. 2 shows a schematic view of the front of the power card 40, and FIG. 3 shows a schematic view of the top of the power card 40. The mold resin 49 (the power card 40) is formed in a shape of a rectangular plate (platelike). The P terminal, the N terminal, and the O terminal are arranged side by side in this order at an end 49a (an edge in a predetermined direction) along one long edge of the mold resin 49 (the power card 40). The P terminal, the N terminal, and the O terminal are formed in a shape of rectangular plates (platelike or rodlike) by a metal alloy (a conductor). The P terminal, the N terminal, and the O terminal are exposed externally from the mold resin 49. The P terminal and the O terminal are located at both ends (near both ends) of the mold resin 49 in the longitudinal direction, respectively. The N terminal is located in the center (near the center) of the mold resin 49 in the longitudinal direction.

FIG. 4 shows a circuit diagram of an output potential switching circuit 30. The output potential switching circuit 30 is equivalent to the circuit 170 for one phase, which is composed of the series connection circuit 162 and the AC switch circuit 165 in FIG. 23. The output potential switching circuit 30 has a first power card 40A and a second power card 40B as the power cards 40. The output potential switching circuit 30 has only the first diode 42, the first switching element 41, the second diode 44, and the second switching element 43, i.e., each element in each power card 40A, 40B, as elements and no other elements. The P terminal of the first power card 40A (a first semiconductor module, one of the semiconductor modules) is connected to the O terminal of the second power card 40B (a second semiconductor module, an other one of the semiconductor modules).

As shown in FIG. 5, the first power card 40A and the second power card 40B are arranged in a stacked manner with the front and back facing away from each other in the thickness direction so that the P terminal of the first power card 40A faces the O terminal of the second power card 40B. Specifically, the first power card 40A and the second power card 40B are arranged adjacent to each other in opposite directions with the ends 49a on which the terminals are arranged facing in the same direction. In the front view (projection perpendicular to a plate surface) of the first power card 40A, an outer edge of the first power card 40A is aligned with an outer edge of the second power card 40B. hen, the P terminal of the first power card 40A is connected to the O terminal of the second power card 40B, as shown by the dashed circle. It should be noted that the N terminal of the first power card 40A and the N terminal of the second power card 40B face each other, and the O terminal of the first power card 40A and the P terminal of the second power card 40B face each other.

FIG. 6 shows a circuit diagram of the output potential switching circuit 30 and its peripheral components. It should be noted that the same reference numerals will be used to omit explanations of parts that can be regarded as identical to those in FIG. 23.

The positive potential Vp is supplied to the P terminal of the second power card 40B, the neutral point potential Vm is supplied to the N terminal of the second power card 40B, and the negative potential Vn is supplied to the N terminal of the first power card 40A. The output potential switching circuit 30 is then applied to a 3-level (multi-level) inverter, which supplies three levels of potential and switches the output potential Vo to one of the three levels of potential to one phase coil of the rotating electric machine 12. Specifically, by turning on the first switching element 41 of the second power card 40B and the first switching element 41 of the first power card 40A, and by turning off the second switching element 43 of the second power card 40B and the second switching element 43 of the first power card 40A, the output potential Vp is output from the O terminal of the first power card 40A. By turning on the second switching element 43 of the second power card 40B and the first switching element 41 of the first power card 40A, and turning off the first switching element 41 of the second power card 40B and the second switching element 43 of the first power card 40A, the neutral point potential Vm is output from the O terminal of the first power card 40A. By turning off the first switching element 41 of the first power card 40A and turning on the second switching element 43 of the first power card 40A, the negative potential Vn is output from the O terminal of the first power card 40A.

In the above, current leaves the O terminal of the second power card 40B and enters the P terminal of the first power card 40A. Therefore, the direction of current flow to the O terminal of the second power card 40B is opposite to the direction of current flow to the P terminal of the first power card 40A. Then, the P terminal of the first power card 40A and the O terminal of the second power card 40B face each other. Therefore, mutual inductance is generated between the O terminal of the second power card 40B and the P terminal of the first power card 40A, and the inductance of the O terminal of the second power card 40B and the P terminal of the first power card 40A is reduced.

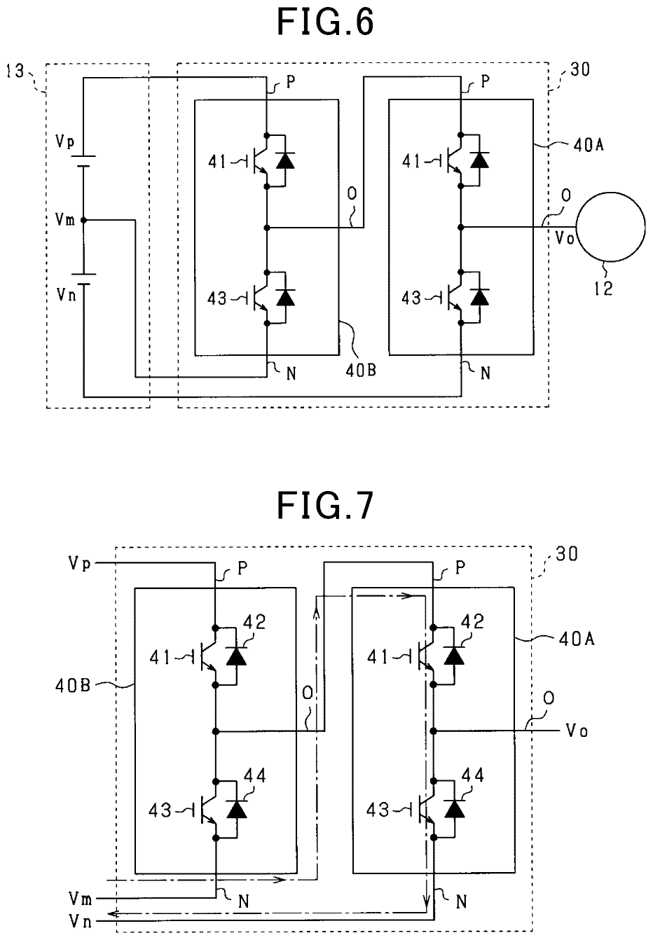

As shown in FIG. 7, when switching from a state in which the first switching element 41 of the second power card 40B is OFF and the second switching element 43 is ON, and the first switching element 41 of the first power card 40A is ON and the second switching element 43 is OFF, to a state in which the first switching element 41 of the first power card 40A is OFF and the second switching element 43 is ON, a surge current as shown by the arrow flows. Here, the inductance of the O terminal of the second power card 40B and the P terminal of the first power card 40A are reduced to suppress this surge current. In addition, the direction of current flow to the N terminal of the second power card 40B is opposite to the direction of current flow to the N terminal of the first power card 40A. Then, as shown in FIG. 5, the N terminal of the first power card 40A and the N terminal of the second power card 40B face each other. Therefore, the inductance of the N terminals of the first power card 40A and the N terminals of the second power card 40B can be reduced, and surge currents can be suppressed.

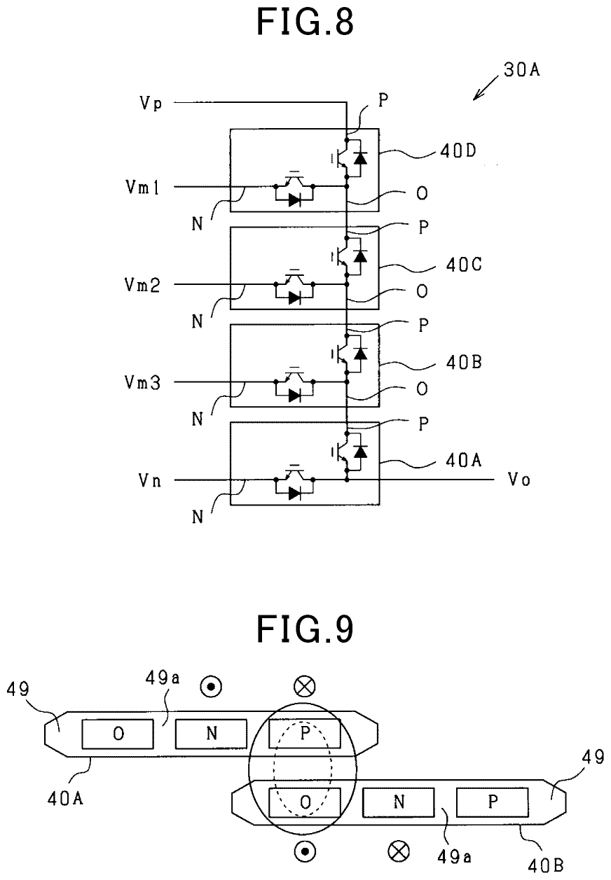

FIG. 8 shows a circuit diagram of an output potential switching circuit 30A applied to a 5-level inverter. The output potential switching circuit 30A has a first power card 40A, a second power card 40B, a third power card 40C, and a fourth power card 40D as the power cards 40. The output potential switching circuit 30A has only the first diode 42, the first switching element 41, the second diode 44, and the second switching element 43, i.e., each element included in each power card 40A to 40D, as elements and no other elements.

The output potential switching circuit 30A is applied to a 5-level (multi-level) inverter, which supplies 5 levels of potential and switches the output potential Vo to one of the 5 levels of potential to one phase coil of the rotating electric machine 12. In this case, the P terminal of the first power card 40A (one of the semiconductor modules) is connected to the O terminal of the second power card 40B (an other one of the semiconductor modules). The P terminal of the second power card 40B (one of the semiconductor modules) is connected to the O terminal of the third power card 40C (an other one of the semiconductor modules). The P terminal of the third power card 40C (one of the semiconductor modules) is connected to the O terminal of the fourth power card 40D (an other one of the semiconductor modules). That is, the P terminal of one of the power cards 40 (one of the semiconductor modules) is connected to the O terminal of the other one of the power cards 40 (an other one of the semiconductor modules), respectively.

In this case, as shown by dots in FIG. 5, the second power card 40B and the third power card 40C are arranged in a stacked manner with the front and back facing away from each other in the thickness direction so that the P terminal of the second power card 40B (one of the semiconductor modules) faces the O terminal of the third power card 40C (other of the semiconductor modules). That is, the third power card 40C is arranged with the front and back facing the same direction as the first power card 40A and overlapped in the thickness direction on the second power card 40B. Furthermore, the third power card 40C and the fourth power card 40D are arranged in reverse front to back and stacked in the thickness direction so that the P terminal of the third power card 40C (one of the semiconductor modules) faces the O terminal of the fourth power card 40D (an other one of the semiconductor modules). That is, the fourth power card 40D is arranged with the front and back facing the same direction as the second power card 40B and overlapped in the thickness direction on the third power card 40C.

As shown in FIG. 8, the positive potential Vp is supplied to the P terminal of the fourth power card 40D, the first neutral point potential Vm1 is supplied to the N terminal of the fourth power card 40D, the second neutral point potential Vm2 is supplied to the N terminal of the third power card 40C, the third neutral point potential Vm3 is supplied to the N terminal of the second power card 40B and the negative potential Vn is supplied to the N terminal of the first power card 40A (Vp>Vm1>Vm2>Vm3>Vn). In other words, the O terminal of the first power card 40A, to which a negative potential Vn (the lowest potential) of the multi-level potential is supplied to the N terminal, is connected to one phase coil of the rotating electric machine 12, and a potential of the multi-level potential higher than the potential supplied to the N terminal of one of the power cards 40 (one of the semiconductor modules) is supplied to the N terminal of another power card 40 (an other one of the semiconductor modules).

In addition, the one-phase circuit composed of the series connection circuit 160 and the AC switch circuit 163 for the U phase in FIG. 23 can also be configured in the same way by the output potential switching circuit 30. The one-phase circuit composed of the series connection circuit 161 and the AC switch circuit 164 for phase V in FIG. 23 can also be configured in the same way by the output potential switching circuit 30. The positional relationship (arrangement) of the output potential switching circuit 30 for phase U, the output potential switching circuit 30 for phase V, and the output potential switching circuit 30 for phase W is arbitrary.

The embodiment detailed above has the following advantages.
The P terminal of the first power card 40A (one of the power cards 40) is connected to the O terminal of the second power card 40B (an other one of the power cards 40). Therefore, by supplying positive potential Vp to the P terminal of the second power card 40B, neutral point potential Vm to the N terminal of the second power card 40B, and negative potential Vn to the N terminal of the first power card 40A, and operating the switching elements 41 and 43 of the first and second power cards 40A and 40B, the output potential Vo output from the O terminal of the first power card 40A can be switched to one of the positive potential Vp, neutral point potential Vm, and negative potential Vn. Therefore, a general-purpose power card 40 can be used to configure the output potential switching circuit 30 applicable to 3-level inverters.
By adding a power card 40, the output potential switching circuit 30A, which is applicable to 5-level inverters (inverters with 4 or more levels), can also be configured.
Since the P terminal of the first power card 40A (one of the power cards 40) and the O terminal of the second power card 40B (an other one of the power cards 40) face each other, it becomes easier to connect the P terminal of the first power card 40A to the O terminal of the second power card 40B. Furthermore, since the direction of current flow to the P terminal of the first power card 40A is opposite to the direction of current flow to the O terminal of the second power card 40B, the inductance of these terminals can be reduced to reduce losses. Moreover, since the first power card 40A and the second power card 40B are arranged in an inverted manner and stacked in the thickness direction, the space required for arranging the multiple power cards 40 can be reduced.
When switching from a state in which the first switching element 41 of the second power card 40B is OFF and the second switching element 43 is ON, and the first switching element 41 of the first power card 40A is ON and the second switching element 43 is OFF, to a state in which the first switching element 41 of the first power card 40A is OFF and the second switching element 43 is ON, the direction of current flow to the N terminal of the second power card 40B and the direction of current flow to the N terminal of the first power card 40A are opposite. In addition, the N terminal of the first power card 40A and the N terminal of the second power card 40B face each other. Therefore, the inductance of the N terminals of the first power card 40A and the N terminals of the second power card 40B can be reduced, and surge currents can be suppressed.
The output potential switching circuit 30 has only the first diode 42, the first switching element 41, the second diode 44, and the second switching element 43 as elements and no other elements. Therefore, the output potential switching circuit 30 can be configured without requiring elements other than those included in the power card 40.

It should be noted that the first embodiment may be implemented with the following modifications. The same parts as in the first embodiment will be omitted from the explanation with the same reference numerals.
As shown in FIG. 9, the first power card 40A and the second power card 40B may be arranged side by side in the thickness direction and facing the same direction on the front and back, so that the P terminal of the first power card 40A (one of the semiconductor modules) faces the O terminal of the second power card 40B (an other one of the semiconductor modules). Specifically, the first power card 40A and the second power card 40B are arranged so that they are partially overlapped (adjacent to each other) in the same direction front to back, with the ends 49a where each terminal is located facing the same direction.

According to the above configuration, since the P terminal of the first power card 40A (one of the semiconductor modules) and the O terminal of the second power card 40B (an other one of the semiconductor modules) face each other, it becomes easier to connect the P terminal of the first power card 40A with the O terminal of the second power card 40B. Furthermore, since the direction of current flow to the P terminal of the first power card 40A (from the P terminal to the inside of the first power card 40A) and the direction of current flow to the O terminal of the second power card 40B (from the inside of the second power card 40B to the O terminal) are opposite, the inductance of these terminals can be reduced to reduce losses.

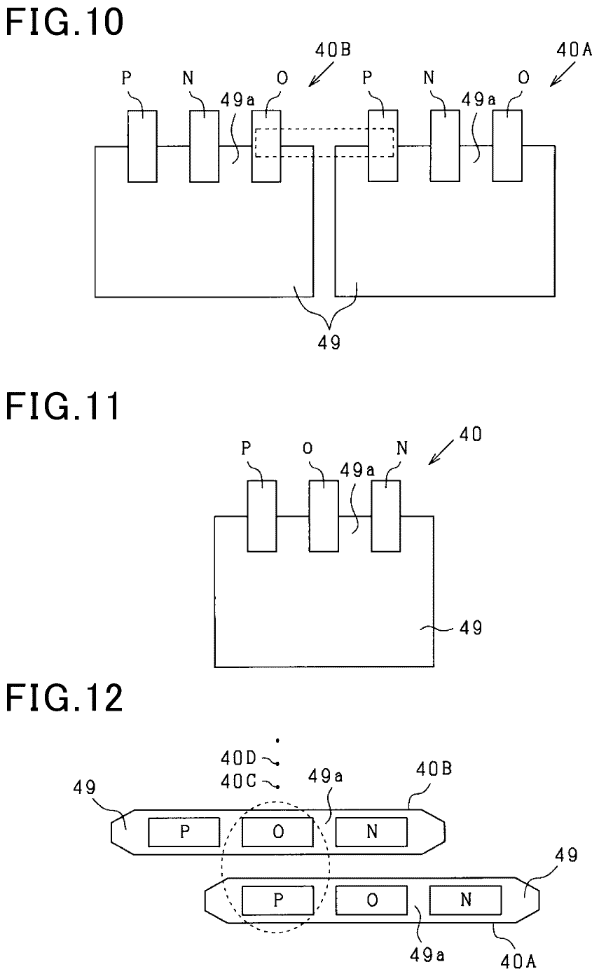

In addition, as shown in FIG. 7, when switching from a state in which the first switching element 41 of the second power card 40B is OFF and the second switching element 43 is ON, and the first switching element 41 of the first power card 40A is ON and the second switching element 43 is OFF, to a state in which the first switching element 41 of the first power card 40A is OFF and the second switching element 43 is ON, the direction of current flow to the N terminal of the second power card 40B and the direction of current flow to the N terminal of the first power card 40A are opposite. Therefore, if the first power card 40A and the second power card 40B are arranged side by side in the thickness direction with the fronts and backs facing the same direction so that the N terminal of the first power card 40A faces the N terminal of the second power card 40B, the inductance of the N terminal of the first power card 40A and the N terminal of the second power card 40B can be reduced, and surge currents can be suppressed.
As shown in FIG. 10, the first power card 40A and the second power card 40B may be arranged with the fronts and backs facing the same direction and aligned in the direction in which the P terminals, the N terminals, and the O terminals are arranged, so that the P terminal of the first power card 40A (one of the semiconductor modules) and the O terminal of the second power card 40B (an other one of the semiconductor modules) are arranged adjacent to each other. Specifically, the first power card 40A and the second power card 40B are arranged adjacent to each other with the front and back facing in the same direction, with the ends 49a on which the terminals are arranged facing in the same direction.

According to the above configuration, since the P terminal of the first power card 40A (one of the semiconductor modules) and the O terminal of the second power card 40B (an other one of the semiconductor modules) are adjacent to each other, it becomes easier to connect the P terminal of the first power card 40A and the O terminal of the second power card 40B. Furthermore, since the direction of current flow to the P terminal of the first power card 40A (from the P terminal to the inside of the first power card 40A) is opposite to the direction of current flow to the O terminal of the second power card 40B (from the inside of the second power card 40B to the O terminal), the inductance of these terminals can be reduced to reduce losses.
As shown in FIG. 11, the P terminal, the O terminal, and the N terminal may be arranged side by side in this order at the end 49a (the edge in a predetermined direction) along one long edge of the mold resin 49 (the power card 40). The P terminal and the N terminal are located at both ends (near both ends) of the mold resin 49 in the longitudinal direction, respectively. The O terminal is located in the center (near the center) of the mold resin 49 in the longitudinal direction.

Then, as shown in FIG. 12, the first power card 40A and the second power card 40B may be arranged side by side in the thickness direction with the fronts and backs facing the same direction so that the P terminal of the first power card 40A (one of the semiconductor modules) faces the O terminal of the second power card 40B (one of the semiconductor modules). Specifically, the first power card 40A and the second power card 40B are arranged so that the ends 49a on which the terminals are arranged face in the same direction and that they partially overlap (are adjacent to each other) with the front and back facing in the same direction.

According to the above configuration, since the P terminal of the first power card 40A (one of the semiconductor modules) and the O terminal of the second power card 40B (an other one of the semiconductor modules) face each other, it becomes easier to connect the P terminal of the first power card 40A with the O terminal of the second power card 40B. Furthermore, since the direction of current flow to the P terminal of the first power card 40A (from the P terminal to the inside of the first power card 40A) and the direction of current flow to the O terminal of the second power card 40B (from the inside of the second power card 40B to the O terminal) are opposite, the inductance of these terminals can be reduced to reduce losses. It should be noted that the same effect can be achieved even if the first power card 40A and the second power card 40B are arranged side by side in the thickness direction with the front and back facing away from each other so that the P terminal of the first power card 40A (one of the semiconductor modules) faces the O terminal of the second power card 40B (an other one of the semiconductor modules).

### Second Embodiment

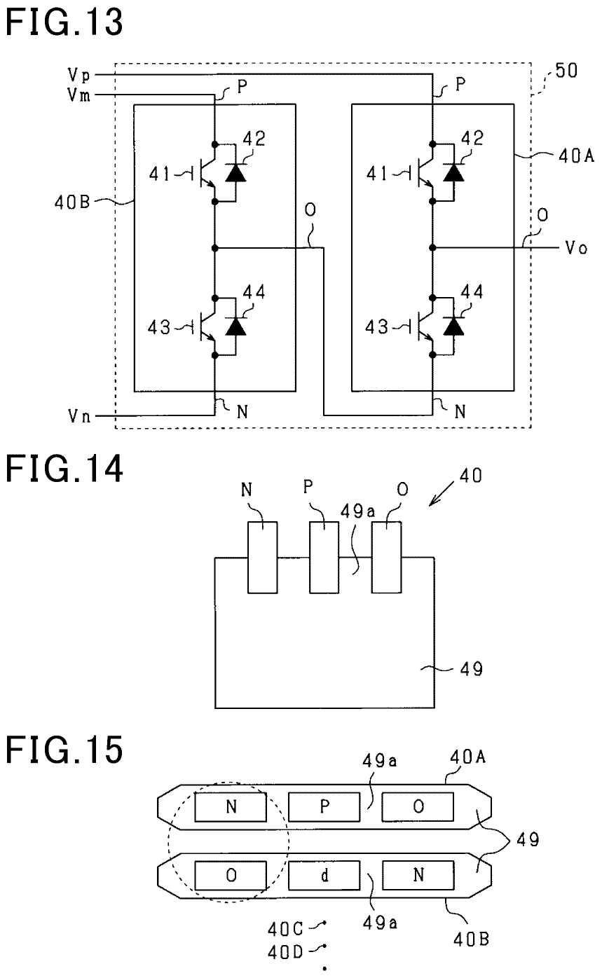

In the present embodiment, a circuit equivalent to the circuit 170 for one phase, which is composed of the series connection circuit 162 and the AC switch circuit 165 in FIG. 23, is composed of an output potential switching circuit 50 shown in FIG. 13. It should be noted that the same parts as in the first embodiment will be omitted from the explanation with the same reference numerals.

The output potential switching circuit 50 has a first power card 40A and a second power card 40B as power cards 40. The output potential switching circuit 50 has only a first diode 42, a first switching element 41, a second diode 44, and a second switching element 43, i.e., each element in each power card 40A, 40B, as elements and no other elements. An N terminal of the first power card 40A (a first semiconductor module, one of the semiconductor modules) is connected to an O terminal of the second power card 40B (a second semiconductor module, an other one of the semiconductor modules).

As shown in FIG. 14, the N terminal, the P terminal, and the O terminal are arranged side by side in this order at an end 49a (an edge in a predetermined direction) along one long edge of the mold resin 49 (the power card 40). The N terminal and the O terminal are located at both ends (near both ends) of the mold resin 49 in the longitudinal direction, respectively. The P terminal is located in the center (near the center) of the mold resin 49 in the longitudinal direction.

As shown in FIG. 15, the first power card 40A and the second power card 40B are arranged in a stacked manner with the front and back facing away from each other in the thickness direction so that the N terminal of the first power card 40A faces the O terminal of the second power card 40B. Specifically, the first power card 40A and the second power card 40B are arranged adjacent to each other in opposite directions with the ends 49a on which the terminals are arranged facing in the same direction. In the front view (projection perpendicular to a plate surface) of the first power card 40A, an outer edge of the first power card 40A is aligned with an outer edge of the second power card 40B. Then, the N terminal of the first power card 40A is connected to the O terminal of the second power card 40B, as shown by the dashed circle. It should be noted that the P terminal of the first power card 40A and the P terminal of the second power card 40B face each other, and the O terminal of the first power card 40A and the N terminal of the second power card 40B face each other.

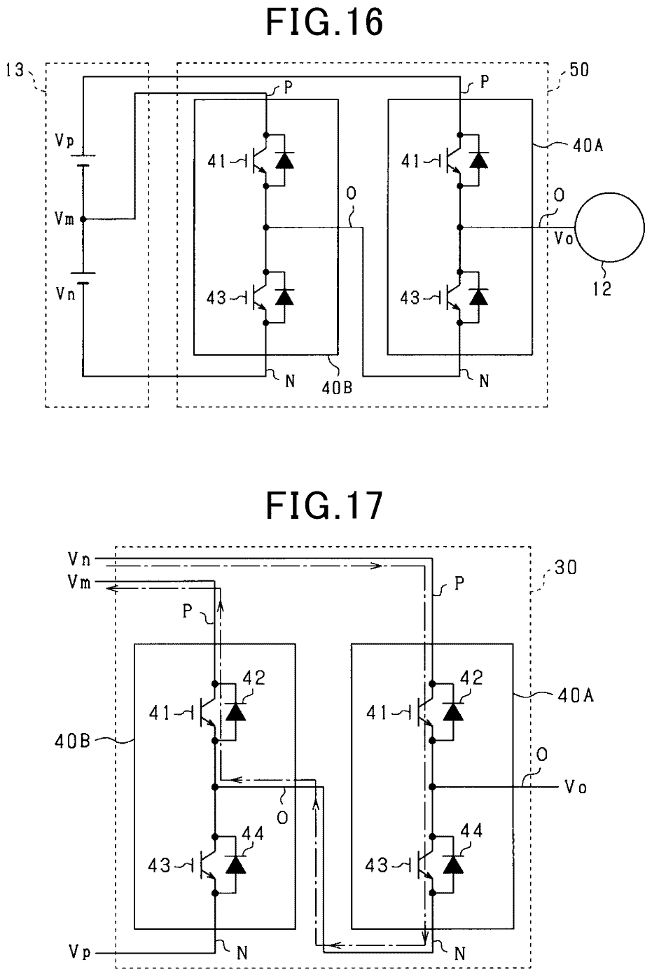

As shown in FIG. 16, the positive potential Vp is supplied to the P terminal of the first power card 40A, the neutral point potential Vm is supplied to the P terminal of the second power card 40B, and the negative potential Vn is supplied to the N terminal of the second power card 40B. The output potential switching circuit 50 also supplies the three levels of potentials, and when the switching elements 41 and 43 of the first and second power cards 40A and 40B are operated, the output potential Vo to one of the three levels of potentials to one phase coil of the rotating electric machine 12 is switched to one of the three levels.

In the above, current leaves the O terminal of the second power card 40B and enters the N terminal of the first power card 40A. Therefore, the direction of current flow to the O terminal of the second power card 40B is opposite to the direction of current flow to the N terminal of the first power card 40A. Then, the N terminal of the first power card 40A and the O terminal of the second power card 40B face each other. Therefore, mutual inductance is generated between the O terminal of the second power card 40B and the N terminal of the first power card 40A, and the inductance of the O terminal of the second power card 40B and the N terminal of the first power card 40A is reduced.

As shown in FIG. 17, when switching from a state in which the first switching element 41 of the second power card 40B is ON and the second switching element 43 is OFF, and the first switching element 41 of the first power card 40A is ON and the second switching element 43 is OFF, to a state in which the first switching element 41 is OFF and the second switching element 43 is ON, the surge current as shown by the arrows flows. Here, the inductance of the O terminal of the second power card 40B and the N terminal of the first power card 40A are reduced to suppress this surge current. In addition, the direction of current flow to the P terminal of the first power card 40A is opposite to the direction of current flow to the P terminal of the second power card 40B. Then, as shown in FIG. 15, the P terminal of the first power card 40A and the P terminal of the second power card 40B face each other. Therefore, the inductance of the P terminal of the first power card 40A and the P terminal of the second power card 40B can be reduced, and the surge current can be suppressed.

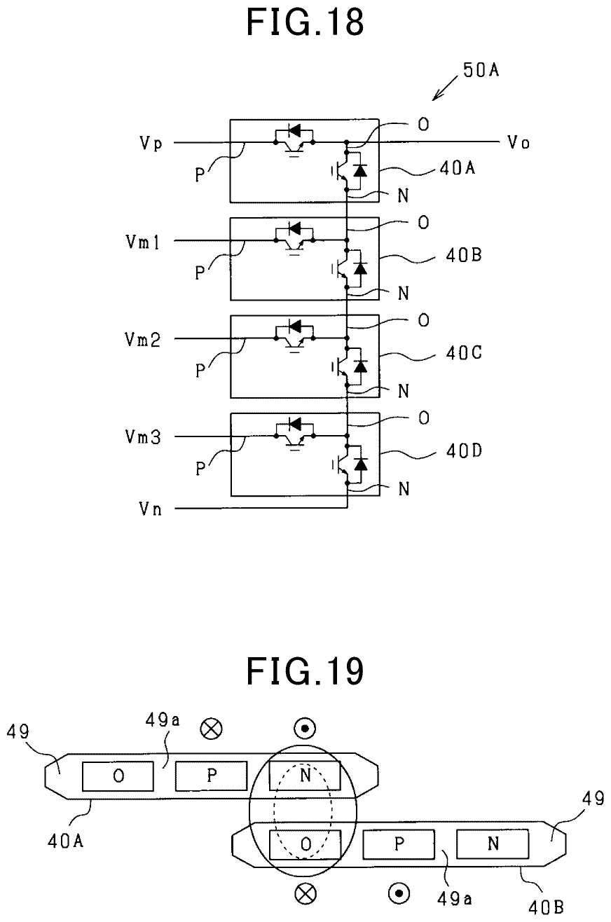

FIG. 18 shows a circuit diagram of an output potential switching circuit 50A applied to a 5-level inverter. The output potential switching circuit 50A has a first power card 40A, a second power card 40B, a third power card 40C, and a fourth power card 40D as the power cards 40. The output potential switching circuit 50A has only the first diode 42, the first switching element 41, the second diode 44, and the second switching element 43, i.e., each element included in each power card 40A to 40D, as elements and no other elements.

The output potential switching circuit 50A is applied to a 5-level (multi-level) inverter, which supplies 5 levels of potential and switches the output potential Vo to one of the 5 levels of potential to one phase coil of the rotating electric machine 12. In this case, the N terminal of the first power card 40A (one of the semiconductor modules) is connected to the O terminal of the second power card 40B (an other one of the semiconductor modules). The N terminal of the second power card 40B (one of the semiconductor modules) is connected to the O terminal of the third power card 40C (an other one of the semiconductor modules). The N terminal of the third power card 40C (one of the semiconductor modules) is connected to the O terminal of the fourth power card 40D (an other one of the semiconductor modules). That is, the N terminal of one of the power cards 40 (one of the semiconductor modules) is connected to the O terminal of another one of the power cards 40, respectively.

In this case, as shown by dots in FIG. 15, the second power card 40B and the third power card 40C are arranged in a stacked manner with the front and back facing away from each other in the thickness direction so that the N terminal of the second power card 40B (one of the semiconductor modules) faces the O terminal of the third power card 40C (other of the semiconductor modules). That is, the third power card 40C is arranged with the front and back facing the same direction as the first power card 40A and overlapped in the thickness direction on the second power card 40B. Furthermore, the third power card 40C and the fourth power card 40D are arranged in reverse front to back and stacked in the thickness direction so that the N terminal of the third power card 40C (one of the semiconductor modules) faces the O terminal of the fourth power card 40D (an other one of the semiconductor modules). That is, the fourth power card 40D is arranged with the front and back facing the same as the second power card 40B and overlapped in the thickness direction on the third power card 40C.

As shown in FIG. 18, the positive potential Vp is supplied to the P terminal of the first power card 40A, the first neutral point potential Vm1 is supplied to the P terminal of the second power card 40B, the second neutral point potential Vm2 is supplied to the P terminal of the third power card 40C, the third neutral point potential Vm3 is supplied to the P terminal of the fourth power card 40D, and the negative potential Vn is supplied to the P terminal of the fourth power card 40D (Vp>Vm1>Vm2>Vm3>Vn). In other words, the O terminal of the first power card 40A, to whose P terminal a positive potential Vp (the highest potential) of the multi-level potential is supplied, is connected to one phase coil of the rotating electric machine 12, and a potential of the multi-level potential lower than the potential supplied to the P terminal of one of the power cards 40 (one of the semiconductor modules) is supplied to the P terminal of another power card 40 (an other one of the semiconductor modules).

In addition, the one-phase circuit composed of the series connection circuit 160 and the AC switch circuit 163 for the U phase in FIG. 23 can also be configured in the same way by the output potential switching circuit 50. The one-phase circuit composed of the series connection circuit 161 and the AC switch circuit 164 for phase V in FIG. 23 can also be configured in the same way by the output potential switching circuit 50. The positional relationship (arrangement) of the output potential switching circuit 50 for phase U, the output potential switching circuit 50 for phase V, and the output potential switching circuit 50 for phase W is arbitrary.

The embodiment detailed above has the following advantages.
The N terminal of the first power card 40A (one of the power cards 40) is connected to the O terminal of the second power card 40B (an other one of the power cards 40). Therefore, by supplying positive potential Vp to the P terminal of the first power card 40A, neutral point potential Vm to the P terminal of the second power card 40B, and negative potential Vn to the N terminal of the second power card 40B, and operating the switching elements 41 and 43 of the first and second power cards 40A and 40B, the output potential Vo output from the O terminal of the first power card 40A can be switched to one of the positive potential Vp, neutral point potential Vm, and negative potential Vn. Therefore, a general-purpose power card 40 can be used to configure the output potential switching circuit 50 applicable to 3-level inverters.
By adding a power card 40, the output potential switching circuit 50A, which is applicable to 5-level inverters (inverters with 4 or more levels), can also be configured.
Since the N terminal of the first power card 40A (one of the power cards 40) and the O terminal of the second power card 40B (an other one of the power cards 40) face each other, it becomes easier to connect the N terminal of the first power card 40A to the O terminal of the second power card 40B. Furthermore, since the direction of current flow to the N terminal of the first power card 40A is opposite to the direction of current flow to the O terminal of the second power card 40B, the inductance of these terminals can be reduced to reduce losses. Moreover, since the first power card 40A and the second power card 40B are arranged in an inverted manner and stacked in the thickness direction, the space required for arranging the multiple power cards 40 can be reduced.
When switching from a state in which the first switching element 41 of the second power card 40B is OFF and the second switching element 43 is ON, and the first switching element 41 of the first power card 40A is ON and the second switching element 43 is OFF, to a state in which the first switching element 41 of the first power card 40A is OFF and the second switching element 43 is ON, the direction of current flow to the P terminal of the second power card 40B and the direction of current flow to the P terminal of the first power card 40A are opposite. In addition, the P terminal of the first power card 40A and the P terminal of the second power card 40B face each other. Therefore, the inductance of the P terminals of the first power card 40A and the P terminals of the second power card 40B can be reduced, and the surge current can be suppressed.
The output potential switching circuit 50 has only the first diode 42, the first switching element 41, the second diode 44, and the second switching element 43 as elements and no other elements. Therefore, the output potential switching circuit 50 can be configured without requiring elements other than those included in the power card 40.

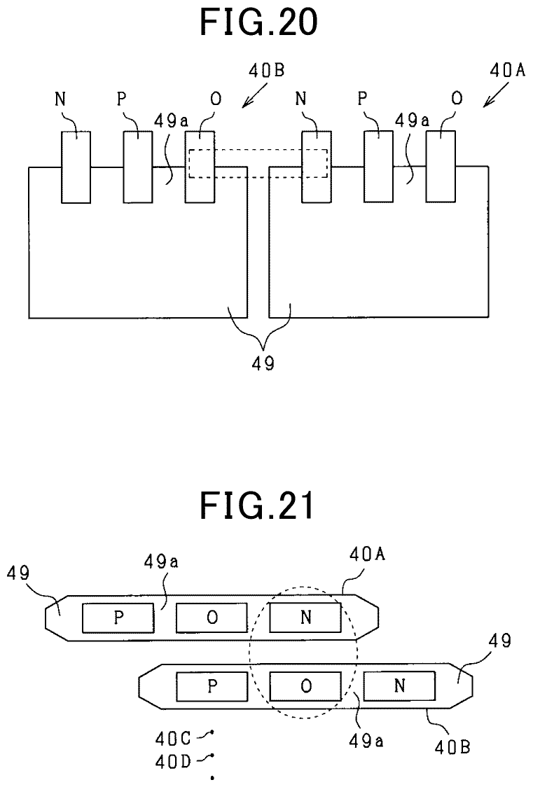

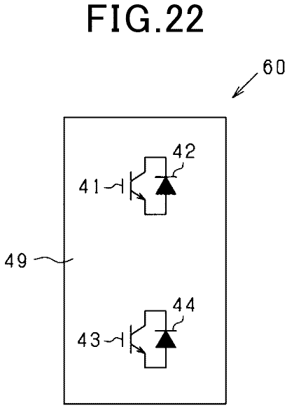

It should be noted that the second embodiment may be implemented with the following modifications. The same parts as in the second embodiment will be omitted from the explanation with the same reference numerals.
As shown in FIG. 19, the first power card 40A and the second power card 40B may be arranged side by side in the thickness direction and facing the same direction front and back, so that the N terminal of the first power card 40A (one of the semiconductor modules) faces the O terminal of the second power card 40B (an other one of the semiconductor modules). Specifically, the first power card 40A and the second power card 40B are arranged so that they are partially overlapped (adjacent to each other) in the same direction front to back, with the ends 49a where each terminal is located facing the same direction. According to such a configuration, the same effects can be achieved as in FIG. 9.
As shown in FIG. 20, the first power card 40A and the second power card 40B may be arranged with the fronts and backs facing the same direction and aligned in the direction in which the N terminals, the P terminals, and the O terminals are arranged, as the N terminal of the first power card 40A (one of the semiconductor modules) and the O terminal of the second power card 40B (one of the semiconductor modules) are arranged adjacent to each other. Specifically, the first power card 40A and the second power card 40B are arranged adjacent to each other with the front and back facing in the same direction, with the ends 49a on which the terminals are arranged facing in the same direction. According to such a configuration, the same effects can be achieved as in FIG. 10.
As shown in FIG. 11, the P terminal, the O terminal, and the N terminal may be arranged side by side in this order at the end 49a (the edge in a predetermined direction) along one long edge of the mold resin 49 (the power card 40). The P terminal and the N terminal are located at both ends (near both ends) of the mold resin 49 in the longitudinal direction, respectively. The O terminal is located in the center (near the center) of the mold resin 49 in the longitudinal direction.

Then, as shown in FIG. 12, the first power card 40A and the second power card 40B may be arranged side by side in the thickness direction with the fronts and backs facing the same direction so that the N terminal of the first power card 40A (one of the semiconductor modules) faces the O terminal of the second power card 40B (one of the semiconductor modules). Specifically, the first power card 40A and the second power card 40B are arranged so that the ends 49a on which the terminals are arranged face in the same direction and that they partially overlap (are adjacent to each other) with the front and back facing in the same direction. According to such a configuration, the same effects can be achieved as in FIG. 12. It should be noted that the same effect can be achieved even if the first power card 40A and the second power card 40B are arranged side by side in the thickness direction with the front and back facing away from each other so that the N terminal of the first power card 40A (one of the semiconductor modules) faces the O terminal of the second power card 40B (an other one of the semiconductor modules).

In addition, in the first embodiment and its modifications, as well as in the second embodiment and its modifications, a power card 60 shown in FIG. 22 can also be employed. The power card 60 has a first switching element 41, a first diode 42, a second switching element 43, a second diode 44, and has no P terminal, wiring connecting the first switching element 41 and the second switching element 43, an O terminal, and an N terminal. The power card 40 may then be configured by providing a P terminal, wiring connecting the first switching element 41 and the second switching element 43, an O terminal, and an N terminal outside the power card 60. It should be noted that it is also possible to employ a power card with a first switching element 41, a first diode 42, a second switching element 43, and a second diode 44, but without at least one of the P terminal, the wiring connecting the first switching element 41 and the second switching element 43, the O terminal, and the N terminal. The power card 40 may then be configured by providing external components that the power card is not equipped with.

It should be noted that each of the above modifications may be implemented in combination.

Although the present disclosure has been described in accordance with examples, it is understood that the present disclosure is not limited to the examples or structures. The present disclosure also encompasses various variants and variations within the scope of equality. In addition, various combinations and forms, as well as other combinations and forms that include only one element, more or less, thereof, also fall within the scope and idea of the present disclosure.

What is claimed is:

1. An output potential switching circuit applicable to a multilevel inverter, and supplies multilevel potentials and switches an output potential to one of the multilevel potentials, the output potential switching circuit comprising:
a plurality of semiconductor modules including:
a first switching element with a first diode connected in inverse parallel,
a second switching element with a second diode connected in inverse parallel,
a P terminal to which a positive terminal of the first switching element is connected,
an O terminal to which a negative terminal of the first switching element and a positive terminal of the second switching element are connected, and
an N terminal to which a negative terminal of the second switching element is connected,
wherein, the P terminal of one of the semiconductor modules is connected to the O terminal of an other one of the semiconductor modules.

2. The output potential switching circuit according to claim 1, wherein
the semiconductor module is formed in a plate shape, and the P terminal, the N terminal, and the O terminal are arranged side by side in this order at an edge of the semiconductor module in a predetermined direction, and
the one of the semiconductor modules and the other one of the semiconductor modules are arranged in a stacked manner with the front and back facing away from each other in the thickness direction so that the P terminal of the one of the semiconductor modules and the O terminal of the other one of the semiconductor modules face each other.

3. The output potential switching circuit according to claim 1, wherein
the semiconductor module is formed in a plate shape, and the P terminal, the N terminal, and the O terminal are arranged side by side in this order at an edge of the semiconductor module in a predetermined direction, and
the one of the semiconductor modules and the other one of the semiconductor modules are arranged side by side in the thickness direction and facing the same direction on the front and back, so that the P terminal of the one of the semiconductor modules faces the O terminal of the other one of the semiconductor modules.

4. The output potential switching circuit according to claim 1, wherein
the semiconductor module is formed in a plate shape, and the P terminal, the N terminal, and the O terminal are arranged side by side in this order at an edge of the semiconductor module in a predetermined direction, and
the one of the semiconductor modules and the other one of the semiconductor modules are arranged with the fronts and backs facing the same direction and aligned in the direction in which the P terminals, the N terminals, and the O terminals are arranged, so that the P terminal of the one of the semiconductor modules and the O terminal of the other one of the semiconductor modules are arranged adjacent to each other.

5. The output potential switching circuit according to claim 1, wherein
the semiconductor module is formed in a plate shape, and the P terminal, the O terminal, and the N terminal are arranged side by side in this order at an edge of the semiconductor module in a predetermined direction, and
the one of the semiconductor modules and the other one of the semiconductor modules are arranged side by side in the thickness direction and facing the same direction or the opposite direction on the front and back, so that the P terminal of the one of the semiconductor modules faces the O terminal of the other one of the semiconductor modules.

6. The output potential switching circuit according to claim 1, wherein
the O terminal of the semiconductor module, to which the lowest potential of the multi-level potential is supplied to the N terminal, is connected to one phase coil of the rotating electric machine, and a potential of the multi-level potential higher than the potential supplied to the N terminal of the one of the semiconductor modules is supplied to the N terminal of the other one of the semiconductor modules.

7. An output potential switching circuit applicable to a multilevel inverter, and supplies multilevel potentials and switches an output potential to one of the multilevel potentials, the output potential switching circuit comprising:
a plurality of semiconductor modules including:
a first switching element with a first diode connected in inverse parallel,
a second switching element with a second diode connected in inverse parallel,
a P terminal to which a positive terminal of the first switching element is connected,
an O terminal to which a negative terminal of the first switching element and a positive terminal of the second switching element are connected, and
an N terminal to which a negative terminal of the second switching element is connected,
wherein, the N terminal of one of the semiconductor modules is connected to the O terminal of an other one of the semiconductor modules.

8. The output potential switching circuit according to claim 7, wherein
the semiconductor module is formed in a plate shape, and the N terminal, the P terminal, and the O terminal are arranged side by side in this order at an edge of the semiconductor module in a predetermined direction, and
the one of the semiconductor modules and the other one of the semiconductor modules are arranged in a stacked manner with the front and back facing away from each other in the thickness direction so that the N terminal of the one of the semiconductor modules and the O terminal of the other one of the semiconductor modules face each other.

9. The output potential switching circuit according to claim 7, wherein
the semiconductor module is formed in a plate shape, and the N terminal, the P terminal, and the O terminal are arranged side by side in this order at an edge of the semiconductor module in a predetermined direction, and
the one of the semiconductor modules and the other one of the semiconductor modules are arranged side by side in the thickness direction and facing the same direction on the front and back, so that the N terminal of the one of the semiconductor modules faces the O terminal of the other one of the semiconductor modules.

10. The output potential switching circuit according to claim 7, wherein
the semiconductor module is formed in a plate shape, and the N terminal, the P terminal, and the O terminal are arranged side by side in this order at an edge of the semiconductor module in a predetermined direction, and
the one of the semiconductor modules and the other one of the semiconductor modules are arranged with the fronts and backs facing the same direction and aligned in the direction in which the N terminals, the P terminals, and the O terminals are arranged, as the N terminal of the one of the semiconductor modules and the O terminal of the other one of the semiconductor modules are arranged adjacent to each other.

11. The output potential switching circuit according to claim 7, wherein
the semiconductor module is formed in a plate shape, and the P terminal, the O terminal, and the N terminal are arranged side by side in this order at an edge of the semiconductor module in a predetermined direction, and
the one of the semiconductor modules and the other one of the semiconductor modules are arranged side by side in the thickness direction and facing the same direction or the opposite direction on the front and back, so that the N terminal of the one of the semiconductor modules faces the O terminal of the other one of the semiconductor modules.

12. The output potential switching circuit according to claim 7, wherein
the O terminal of the semiconductor module, to which the highest potential of the multi-level potential is supplied to the P terminal, is connected to one phase coil of the rotating electric machine, and a potential of the multi-level potential lower than the potential supplied to the P terminal of the one of the semiconductor modules is supplied to the P terminal of the other one of the semiconductor modules.

13. An output potential switching circuit applicable to a multilevel inverter, and supplies multilevel potentials and switches an output potential to one of the multilevel potentials, the output potential switching circuit comprising:
a plurality of semiconductor modules including:
a first switching element with a first diode connected in inverse parallel,
a second switching element with a second diode connected in inverse parallel,
a P terminal to which a positive terminal of the first switching element is connected,
an O terminal to which a negative terminal of the first switching element and a positive terminal of the second switching element are connected, and
an N terminal to which a negative terminal of the second switching element is connected,
wherein, only the first diode, the first switching element, the second diode, and the second switching element are provided as elements, and no other elements are provided.
